(19) United States
(12) Patent Application Publication
(10) Pub. No.: US 2026/0061369 A1
(43) Pub. Date: Mar. 5, 2026

(54) METHANE PURIFICATION APPARATUS

(71) Applicant: ISUZU MOTORS LIMITED, Yokohama-shi (JP)

(72) Inventor: Naoya ISHIKAWA, Fujisawa-shi (JP)

(21) Appl. No.: 19/275,167

(22) Filed: Jul. 21, 2025

(30) Foreign Application Priority Data
Sep. 4, 2024 (JP) 2024-152454

(51) Int. Cl. B01D 53/86; B01D 53/34; B01D 53/94

(52) U.S. Cl. CPC B01D 53/8668; B01D 53/346; B01D 53/94; B01D 2251/104; B01D 2255/20738; B01D 2255/20746; B01D 2255/50; B01D 2255/9045; B01D 2257/7025; B01D 2258/01; B01D 2258/06

(57) ABSTRACT

A methane purification apparatus includes a flow path through which a gas containing methane flows, an ozone supply unit that supplies ozone to the gas, a catalyst structure that is provided downstream of the ozone supply unit in the flow path and purifies the methane by causing the ozone to react with the methane, and a heater that is in contact with the catalyst structure in the flow path and heats the catalyst structure.

### CROSS-REFERENCE TO RELATED APPLICATIONS

The present application claims priority to Japanese Patent Applications number 2024-152454, filed on Sep. 4, 2024 contents of which are incorporated herein by reference in their entirety.

### BACKGROUND OF THE INVENTION

The present disclosure relates to a methane purification apparatus for purifying methane in a gas.

Japanese Unexamined Patent Application Publication No. 2021-505376 discloses a technique in which a gas containing methane and ozone is supplied to a catalyst, and the methane and ozone react on the catalyst to purify the methane. Specifically, the methane is purified by being decomposed into carbon dioxide and water through a reaction with ozone.

Water generated by the reaction of methane with ozone may remain on the catalyst. When water remains on the catalyst, it becomes difficult for methane and ozone to contact the catalyst, thereby inhibiting the reaction between methane and ozone.

### BRIEF SUMMARY OF THE INVENTION

The present disclosure focuses on this point, and an object thereof is to promote a reaction between methane and ozone on a catalyst.

An aspect of the present disclosure provides a methane purification apparatus including a flow path through which a gas containing methane flows, an ozone supply unit that supplies ozone to the gas, a catalyst structure that is provided downstream of the ozone supply unit in the flow path and purifies the methane by causing the ozone to react with the methane, and a heater that is in contact with the catalyst structure in the flow path and heats the catalyst structure.

### BRIEF DESCRIPTION OF THE DRAWINGS

FIG. 1 schematically shows a configuration of a methane purification apparatus 1 according to an embodiment.

FIG. 2 schematically shows an example of a configuration of a methane decomposition unit 30.

FIG. 3 is an exploded schematic view of the methane decomposition unit 30.

FIG. 4 schematically illustrates a modification.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### Configuration of Methane Purification Apparatus

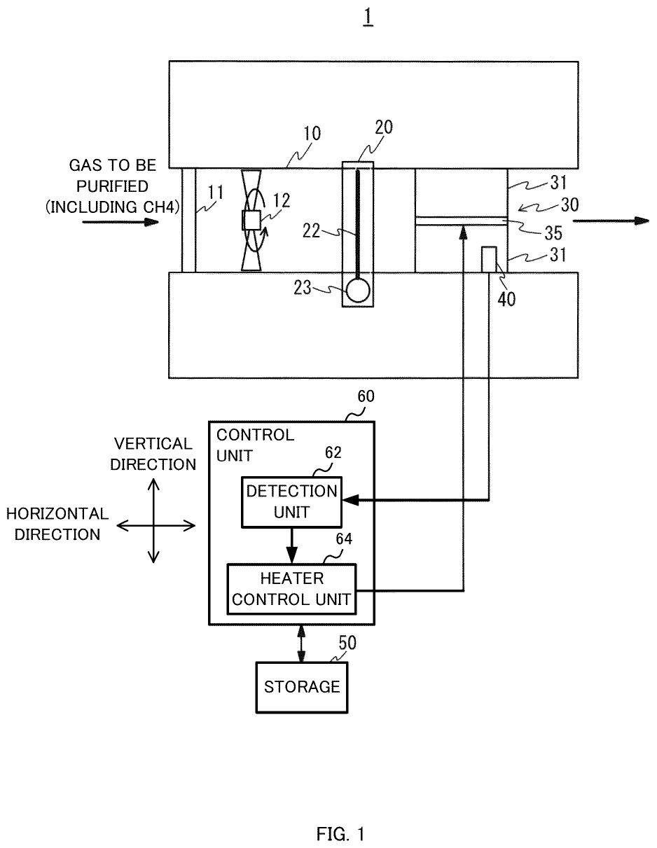

FIG. 1 schematically shows a configuration of a methane purification apparatus 1 according to an embodiment.

The methane purification apparatus 1 is an apparatus for purifying a gas to be purified, which is a gas containing methane. Here, the gas to be purified is air containing methane. The methane purification apparatus 1 can be installed in a factory, a house, or the like. The methane purification apparatus 1 includes a flow path 10, a filter 11, a fan 12, an ozone supply unit 20, a methane decomposition unit 30, a temperature sensor 40, a storage 50, and a control unit 60.

The flow path 10 forms a flow path through which the gas to be purified containing methane flows. The flow path 10 is a tube having a rectangular cross section, for example. However, the present disclosure is not limited thereto, and the cross section of the flow path 10 may be circular. In the flow path 10, the filter 11, the fan 12, the ozone supply unit 20, the methane decomposition unit 30, and the temperature sensor 40 are provided.

The filter 11 removes dust and specific components in the gas to be purified (such as hydrocarbons, which may inhibit the reaction between methane and ozone). The filter 11 is provided in the vicinity of the inlet of the flow path 10 through which the gas to be purified flows. It should be noted that the filter 11 may be omitted.

The fan 12, by rotating, draws the gas to be purified containing methane into the flow path 10. The gas to be purified drawn in by the fan 12 flows toward the methane decomposition unit 30 located downstream of the fan 12. The fan 12 is provided in the flow path 10, but the present disclosure is not limited thereto, and the fan 12 may be provided outside the flow path 10.

The ozone supply unit 20 is provided downstream of the fan 12 in the flow path 10, and supplies ozone to the gas to be purified drawn in by the fan 12. The ozone supply unit 20 generates ozone and supplies the ozone to the gas to be purified containing methane. The ozone flows toward the methane decomposition unit 30 together with the gas to be purified. Specifically, the ozone flows toward the methane decomposition unit 30 in a state of being mixed with the gas to be purified.

The ozone supply unit 20 generates ozone by performing silent discharge on the gas to be purified (a so-called silent discharge method), for example. Specifically, the ozone supply unit 20 generates ozone by applying an AC voltage from a power source 23 to an electrode 22 covered with a dielectric material such as glass. However, the present disclosure is not limited to the above, and the ozone supply unit 20 may generate ozone by performing a process of electrolyzing water (a so-called electrolysis method), or by irradiating the gas to be purified with ultraviolet rays (a so-called ultraviolet lamp method).

The methane decomposition unit 30 is provided downstream of the ozone supply unit 20 in the flow path 10, and has a function of decomposing methane in a gas to be purified using ozone. The methane decomposition unit 30 has a catalyst structure 31 for decomposing methane, and decomposes methane into water and carbon dioxide by causing ozone and methane to react with each other on a catalyst.

Water generated by the reaction of methane with ozone remains on the catalyst of the catalyst structure 31. When water remains on the catalyst, it becomes difficult for methane and ozone to contact the catalyst, thereby inhibiting the reaction between methane and ozone. As a result, the methane purification efficiency in the methane decomposition unit 30 is reduced.

Therefore, in the present embodiment, the methane decomposition unit 30 includes a heater 35 that heats the catalyst structure 31, and the heater 35 is in contact with the catalyst structure 31. In this case, the heater 35 directly heats the catalyst structure 31, and temperature of the catalyst of the catalyst structure 31 increases. Thus, moisture remaining on the catalyst is evaporated and removed from the catalyst. As a result, methane and ozone can appropriately contact the catalyst, thereby promoting the reaction between methane and ozone on the catalyst.

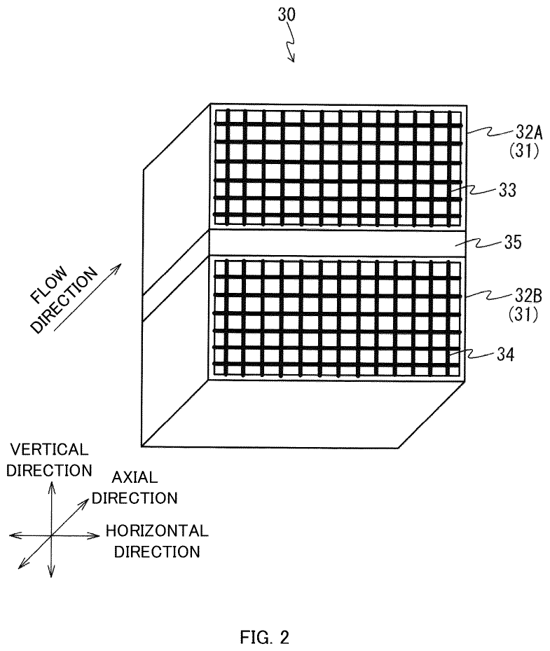

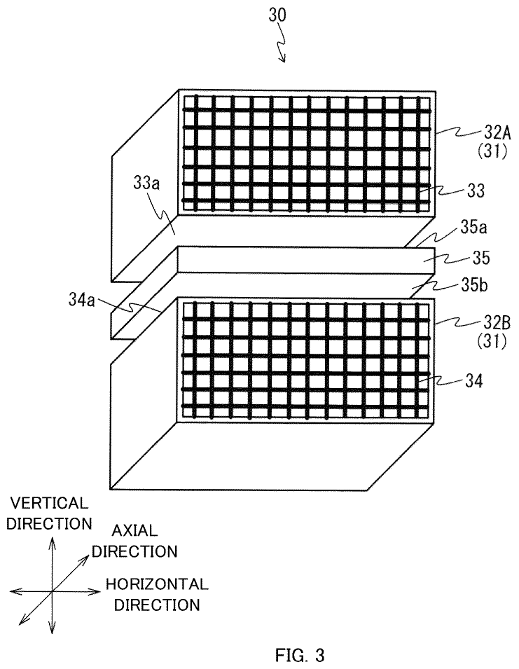

FIG. 2 schematically shows an example of a configuration of the methane decomposition unit 30. FIG. 3 is an exploded schematic view of the methane decomposition unit 30. It should be noted that, in FIG. 2, the direction in which the gas to be purified and ozone flow through the methane decomposition unit 30 is indicated by an arrow. Here, the catalyst structure 31 of the methane decomposition unit 30 is divided into two parts. As illustrated in FIG. 3, the methane decomposition unit 30 includes a first catalyst structure 32A, a second catalyst structure 32B, and a heater 35.

The first catalyst structure 32A is provided downstream of the ozone supply unit 20 in the flow path 10, and purifies methane by causing ozone to react with methane in the gas to be purified. The methane decomposition unit 30 has a rectangular parallelepiped shape. However, the present disclosure is not limited thereto, and the methane decomposition unit 30 may have a cylindrical shape.

The first catalyst structure 32A is located above the heater 35 and is in contact with the heater 35. Specifically, a lower surface 33a of the first catalyst structure 32A (FIG. 3) is in contact with an upper surface 35a of the heater 35 (FIG. 3). The first catalyst structure 32A is located in the upper half of the flow path 10 when viewed from the heater 35. The lower surface 33a, which is a first side surface of the first catalyst structure 32A, faces an upper surface 34a, which is a second side surface of the second catalyst structure 32B, with the heater 35 interposed therebetween.

The first catalyst structure 32A includes a first carrier 33 that supports a catalyst. Here, the first carrier 33 has a honeycomb structure. However, the present disclosure is not limited thereto, and the first carrier 33 may have a corrugated, mesh, or porous structure, for example. The material of the first carrier 33 is, for example, cordierite, silicon carbide, aluminum titanate, stainless steel, an iron-chromium aluminum alloy, glass wool, glass fiber, or titanium. By using a thermally conductive carrier, the heat from the heater 35 is more easily transmitted throughout the first catalyst structure 32A, thereby facilitating the reaction between ozone and methane on the catalyst of the first catalyst structure 32A.

A catalyst layer to which a catalyst adheres is formed on a surface of the first carrier 33. The catalyst of the catalyst layer here includes any of a zeolite, an iron ion-exchanged zeolite, and a cobalt ion-exchanged zeolite. Here, the catalyst layer is formed on the entire surface of the first carrier 33. However, the present disclosure is not limited thereto, and there may be a region on the surface of the first carrier 33 where no catalyst layer is formed.

Similarly to the first catalyst structure 32A, the second catalyst structure 32B is provided downstream of the ozone supply unit 20, and purifies methane by causing ozone to react with methane. Similarly to the first catalyst structure 32A, the second catalyst structure 32B has a rectangular parallelepiped shape. The second catalyst structure 32B is located below the heater 35 and is in contact with the heater 35. Specifically, an upper surface 34a of the second catalyst structure 32B (FIG. 3) is in contact with a lower surface 35b of the heater 35 (FIG. 3). The second catalyst structure 32B is located in the lower half of the flow path 10 when viewed from the heater 35.

Similarly to the first catalyst structure 32A, the second catalyst structure 32B includes a second carrier 34 that supports a catalyst. Further, a catalyst layer to which the catalyst adheres is formed on the surface of the second carrier 34. The second carrier 34 and the catalyst layer of the second catalyst structure 32B have the same configuration as the first carrier 33 and the catalyst layer of the first catalyst structure 32A. Accordingly, ozone and methane easily react on the catalyst of the second catalyst structure 32B.

The heater 35 is disposed between the first catalyst structure 32A and the second catalyst structure 32B in the flow path 10, and heats the first catalyst structure 32A and the second catalyst structure 32B. Specifically, the heater 35 is in contact with both the first carrier 33 of the first catalyst structure 32A and the second carrier 34 of the second catalyst structure 32B, and heats the first carrier 33 and the second carrier 34. The heater 35 includes a heat generating unit that generates heat when supplied with electricity. The heat generating unit includes an electric heating wire that converts electrical energy into thermal energy, for example.

When the heater 35 heats the first carrier 33 and the second carrier 34, temperatures of the catalysts of the first carrier 33 and the second carrier 34 increase. In particular, when the first carrier 33 and the second carrier 34 have a honeycomb structure, heat from the heater 35 is easily transmitted to the first carrier 33 and the second carrier 34, making it easier for the temperatures of the catalysts to increase. Thus, moisture remaining on the catalyst is evaporated and removed from the catalyst. As a result, methane and ozone can appropriately contact the catalyst, thereby promoting the reaction between methane and ozone on the catalyst.

The heater 35 has a flat plate shape, and is located in the center of the flow path 10 along the axial direction of the flow path 10 (see FIG. 1). The thickness of the heater 35 is preferably as small as possible so as not to hinder the flow of gas in the flow path 10, and is approximately one-tenth of the thickness of the first catalyst structure 32A, for example.

The heater 35 is in contact with both a first side surface of the first carrier 33 of the first catalyst structure 32A and a second side surface of the second carrier 34 of the second catalyst structure 32B. Specifically, the upper surface 35a of the heater 35 is in contact with the lower surface 33a of the first carrier 33, and the lower surface 35b of the heater 35 is in contact with the upper surface 34a of the second carrier 34. Thus, the first carrier 33 and the second carrier 34 can be efficiently heated by one heater 35. In particular, since the heater 35 is located at the center of the flow path 10, the first carrier 33 and the second carrier 34 located above and below the heater 35 can be easily uniformly heated, and moisture remaining on the catalyst can be efficiently removed.

The heater 35 may be fixed to the first catalyst structure 32A and the second catalyst structure 32B with a thermally conductive adhesive. Specifically, the heater 35 is fixed to the lower surface 33a of the first carrier 33 and the upper surface 34a of the second carrier 34 with a thermally conductive adhesive. The thermally conductive adhesive may be any material as long as it is thermally conductive. Accordingly, the heat generated by the heater 35 is appropriately transmitted to the first carrier 33 and the second carrier 34.

It should be noted that it may be considered to dispose the heater 35 upstream of the methane decomposition unit 30. However, when the heater 35 is located upstream of the methane decomposition unit 30, there is a possibility that ozone may come into contact with the heater 35 before reaching the catalyst of the methane decomposition unit 30. Since ozone reacts in the heater 35, the ozone is converted into oxygen. In such a case, the amount of ozone available to react with methane decreases.

In contrast, by disposing the heater 35 between the first catalyst structure 32A and the second catalyst structure 32B as in the present embodiment, it is possible to suppress contact between ozone and the heater 35, and as a result, suppress a decrease in ozone.

Returning to FIG. 1, the configuration of the methane purification apparatus 1 will be described.

The temperature sensor 40 is provided in the flow path 10 and is a sensor for detecting temperature around the methane decomposition unit 30. Specifically, the temperature sensor 40 detects temperatures of the gas to be purified and ozone flowing through the methane decomposition unit 30. The temperature sensor 40 is a thermistor or a thermocouple, for example, and is provided in the methane decomposition unit 30 (specifically, the catalyst structure 31) here. However, the present disclosure is not limited thereto, and the temperature sensor 40 may be provided downstream of the catalyst structure 31.

The storage 50 includes a storage medium such as a Read Only Memory (ROM), a Random Access Memory (RAM), a Hard Disk Drive (HDD), or a Solid State Drive (SSD), for example. The storage 50 stores a program executed by the control unit 60 and various kinds of information for decomposing methane.

The control unit 60 includes a processor such as a Central Processing Unit (CPU). The controller 60 heats the first catalyst structure 32A and the second catalyst structure 32B by supplying electricity to the heater 35. As a result, methane and ozone react with each other on the catalyst whose temperature has been increased. The control unit 60 may be configured by a single processor, or may be configured by a plurality of processors or a combination of one or more processors and an electronic circuit. The control unit 60 functions as a detection unit 62 and a heater control unit 64 by executing the program stored in the storage 50.

The detection unit 62 detects temperature of the catalyst of the methane decomposition unit 30. For example, the detection unit 62 detects the temperature of the catalyst of the methane decomposition unit 30 (specifically, the catalyst structure 31) by acquiring the temperature detected by the temperature sensor 40. For example, the detection unit 62 detects the temperature detected by the temperature sensor 40 as the temperature of the catalyst. However, the present disclosure is not limited thereto, and the detection unit 62 may detect a value obtained by multiplying the temperature detected by the temperature sensor 40 by a predetermined coefficient as the temperature of the catalyst.

The heater control unit 64 controls the operation of the heater 35. For example, when the ozone supply unit 20 starts supplying ozone to the gas to be purified, the heater control unit 64 operates the heater 35 to heat the catalyst structure 31 (specifically, the first carrier 33 and the second carrier 34). Further, the heater control unit 64 controls the operation of the heater 35 based on the temperature detected by the detection unit 62.

Ozone is known to undergo thermal decomposition within a few seconds when the temperature exceeds a predetermined first temperature (e.g., 300° C.). When ozone is thermally decomposed, the amount of ozone available to react with methane decreases. Therefore, the heater control unit 64 operates the heater 35 so that the temperature of the catalyst is below the first temperature at which ozone decomposes. Specifically, the heater control unit 64 controls the supply of electricity to the heater 35 so that the temperature of the catalyst, as detected by the detection unit 62, is below the first temperature. Accordingly, thermal decomposition of ozone can be suppressed during operation of the heater 35.

In addition, in order to suppress the state in which water remains on the catalyst, the heater control unit 64 may operate the heater 35 so that the temperature of the catalyst, as detected by the detection unit 62, becomes lower than the first temperature and equal to or higher than the second temperature (for example, 100° C.) at which moisture evaporates.

### Modification

The heater 35 has been described above as being disposed between the first catalyst structure 32A and the second catalyst structure 32B in a vertical arrangement, but the present disclosure is not limited thereto. For example, the heater 35 may be disposed between the first catalyst structure 32A and the second catalyst structure 32B in a horizontal arrangement.

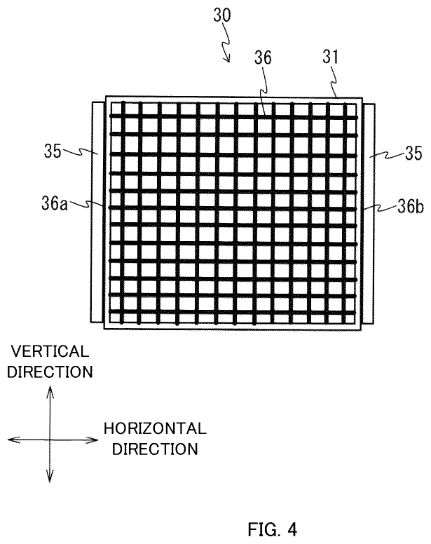

In addition, the catalyst structure 31 has been described above as being divided into the first catalyst structure 32A and the second catalyst structure 32B, and the heater 35 is disposed between the first catalyst structure 32A and the second catalyst structure 32B, but the present disclosure is not limited thereto. For example, one catalyst structure 31 may be provided, and heaters 35 may be disposed as shown in FIG. 4.

FIG. 4 schematically illustrates a modification. In the modification, two heaters 35 are in contact with respective the outer surfaces of the one catalyst structure 31. Specifically, one heater 35 is in contact with a left side surface 36a of a carrier 36 of the catalyst structure 31, and the other heater 35 is in contact with a right side surface 36b of the carrier 36. In this case, since the catalyst structure 31 is heated by the two heaters 35, the temperature of the catalyst of the catalyst structure 31 increases. Thus, moisture remaining on the catalyst is evaporated and removed from the catalyst.

It should be noted that, in the modification, the two heaters 35 are described as being disposed on the left and right sides of the catalyst structure 31, but the present disclosure is not limited thereto. For example, the heater 35 may be provided so as to wrap around the outer surface of the catalyst structure 31. Furthermore, in the above description, the heater 35 is in contact with the outer surface of the catalyst structure 31, but the present disclosure is not limited thereto. For example, the heater 35 may be disposed in a rod shape inside the catalyst structure 31.

In the above description, the methane purification apparatus 1 purifies methane contained in the air in the above description, but the present disclosure is not limited thereto. For example, the methane purification apparatus 1 may purify methane contained in exhaust gas discharged from an internal combustion engine of a vehicle or the like. In such a case, the methane purification apparatus 1 is provided in an exhaust passage of the internal combustion engine, and purifies methane in the exhaust gas flowing through the exhaust passage.

### Effects of Embodiment

The methane purification apparatus 1 of the above-described embodiment includes the catalyst structure 31 that is provided downstream of the ozone supply unit 20 in the flow path 10 and purifies methane by causing ozone to react with methane, and the heater 35 that is in contact with the catalyst structure 31 in the flow path 10 and heats the catalyst structure 31.

When the heater 35 directly heats the catalyst structure 31, the temperature of the catalyst of the catalyst structure 31 increases. Thus, moisture remaining on the catalyst is evaporated and removed from the catalyst. As a result, methane and ozone can appropriately contact the catalyst, thereby promoting the reaction between methane and ozone on the catalyst.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A methane purification apparatus comprising:
a flow path through which a gas containing methane flows;
an ozone supply unit that supplies ozone to the gas;
a catalyst structure that is provided downstream of the ozone supply unit in the flow path and purifies the methane by causing the ozone to react with the methane; and
a heater that is in contact with the catalyst structure in the flow path and heats the catalyst structure.

2. The methane purification apparatus according to claim 1, wherein
the catalyst structure has a carrier having a honeycomb structure supporting a catalyst, and
the heater is in contact with a side surface of the carrier.

3. The methane purification apparatus according to claim 1, wherein
the catalyst structure is divided into a first catalyst structure and a second catalyst structure, and
the heater is disposed between the first catalyst structure and the second catalyst structure.

4. The methane purification apparatus according to claim 3, wherein
the heater has a flat plate shape, and is located at the center of the flow path along an axial direction of the flow path.

5. The methane purification apparatus according to claim 4, wherein
a first side surface of the first catalyst structure faces a second side surface of the second catalyst structure, with the heater interposed therebetween, and
the heater is in contact with both the first side surface and the second side surface.

6. The methane purification apparatus according to claim 3, wherein
the heater is fixed to the first catalyst structure and the second catalyst structure with a thermally conductive adhesive.

7. The methane purification apparatus according to claim 1, wherein
the catalyst structure has a rectangular parallelepiped shape, and
the heaters are in contact with each of two opposing outer surfaces of the catalyst structure.

8. The methane purification apparatus according to claim 1, wherein
the catalyst includes any of a zeolite, an iron ion-exchanged zeolite, and a cobalt-ion exchanged zeolite.

9. The methane purification apparatus according to claim 1, further comprising:
a heater control unit that operates the heater to heat the catalyst structure when the ozone supply unit starts supplying ozone to the gas.
